(19) United States
(12) Patent Application Publication
(10) Pub. No.: US 2025/0081256 A1
(43) Pub. Date: Mar. 6, 2025

(54) MULTI-LINK PROCEDURE FOR PREMIUM LINK ACCESS

(71) Applicant: Cisco Technology, Inc., San Jose, CA (US)

(72) Inventors: Binita GUPTA, San Diego, CA (US); Malcolm M. SMITH, Richardson, TX (US); Brian D. HART, Sunnyvale, CA (US); Venkataprasad CHIRREDDY, Milpitas, CA (US)

(21) Appl. No.: 18/825,124

(22) Filed: Sep. 5, 2024

Related U.S. Application Data
(60) Provisional application No. 63/580,618, filed on Sep. 5, 2023.

(51) Int. Cl. H04W 76/10; H04W 28/02; H04W 28/24

(52) U.S. Cl. CPC H04W 76/10; H04W 28/0268; H04W 28/24

(57) ABSTRACT

The present disclosure describes an access point that shifts data streams subject to QoS requirements to links that are mapped to handle such traffic. The access point includes one or more memories and one or more processors communicatively coupled to the one or more memories. The one or more processors determine, based on a first traffic identifier for a first data stream, that the first data stream is subject to QoS requirements and in response to determining that the first data stream is subject to QoS requirements, determine a first link that is mapped to the first traffic identifier. The one or more processors carry the first data stream on the first link.

### CROSS-REFERENCE TO RELATED APPLICATIONS

This application claims benefit of co-pending U.S. provisional patent application Ser. No. 63/580,618 filed Sep. 5, 2023. The aforementioned related patent application is herein incorporated by reference in its entirety.

### TECHNICAL FIELD

Embodiments presented in this disclosure generally relate to wireless communication. More specifically, embodiments disclosed herein relate to a multi-link procedure for premium link access.

### BACKGROUND

Access points may facilitate wireless communication in network deployments. These access points may provide multiple communication links through which devices may transmit data streams to and/or receive data streams from the access point. In some instances, some data streams (e.g., video conferencing data streams, virtual reality data streams, etc.) may be subject to quality of service (QOS) requirements. If a link does not satisfy the QoS requirements for a data stream on the link (e.g., due to congestion on the link), then the data stream may be slowed and applications that rely on the data stream may be disrupted.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A illustrates an example system.

FIG. 1B illustrates an example access point in the system of FIG. 1A.

FIG. 2 illustrates an example mapping in the system of FIG. 1A.

FIGS. 3A through 3D illustrate example operations performed by the system of FIG. 1A.

FIG. 4 illustrates an example operation performed by the system of FIG. 1A.

FIGS. 5A and 5B illustrate example operations performed by the system of FIG. 1A.

FIG. 6 illustrates an example operation performed by the system of FIG. 1A.

FIG. 7 is a flowchart of an example method performed by the system of FIG. 1A.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes an access point that carries data streams subject to QoS requirements on links that are mapped to handle such traffic. According to an embodiment, an access point includes one or more memories and one or more processors communicatively coupled to the one or more memories. The one or more processors determine, based on a first traffic identifier for a first data stream, that the first data stream is subject to QoS requirements and in response to determining that the first data stream is subject to QoS requirements, determine a first link that is mapped to the first traffic identifier. The one or more processors carry the first data stream on the first link.

According to another embodiment, a method includes determining, based on a first traffic identifier for a first data stream, that the first data stream is subject to QoS requirements and in response to determining that the first data stream is subject to QoS requirements, determining a first link that is mapped to the first traffic identifier. The method also includes carrying the first data stream on the first link.

According to another embodiment, a non-transitory computer readable medium stores instructions that, when executed by one or more processors, causes the one or more processors to determine, based on a first traffic identifier for a first data stream, that the first data stream is subject to QoS requirements and in response to determining that the first data stream is subject to QoS requirements, determine a first link that is mapped to the first traffic identifier. The instructions also cause the one or more processors to carry the first data stream on the first link.

### Example Embodiments

The present disclosure describes an access point that carries data streams subject to QoS requirements on links that are mapped to prioritize such traffic or mapped to be reserved for such traffic. Generally, the access point implements multiple links, and the access point maintains a mapping that indicates the traffic identifiers handled by each link. The traffic identifiers identify types of traffic included in data streams. Certain traffic identifiers indicate traffic that is subject to QoS requirements. Some of the links may be mapped to every traffic identifier (e.g., indicating that those links may handle every type of traffic), but some links may be mapped to a subset of the traffic identifiers (e.g., only traffic identifiers for traffic subject to QoS requirements). These links may also be referred to as “premium links.” When the access point receives a data stream with a traffic identifier indicating traffic subject to QoS requirements, the access point may determine, from the mapping, the premium links that are mapped to the traffic identifier for the data stream. The access point may then carry the data stream on one or more of these links.

In certain embodiments, the access point provides several technical advantages. For example, by carrying the data stream that is subject to QoS requirements on a premium link, the access point improves the quality of the communication for the data stream and ensures that applications that rely on that data stream are not disrupted and operate smoothly. As another example, because data streams that are subject to QoS requirements typically cause more congestion than other types of data streams, the access point improves communication over other links by carrying the data streams that are subject to QoS requirements on premium links.

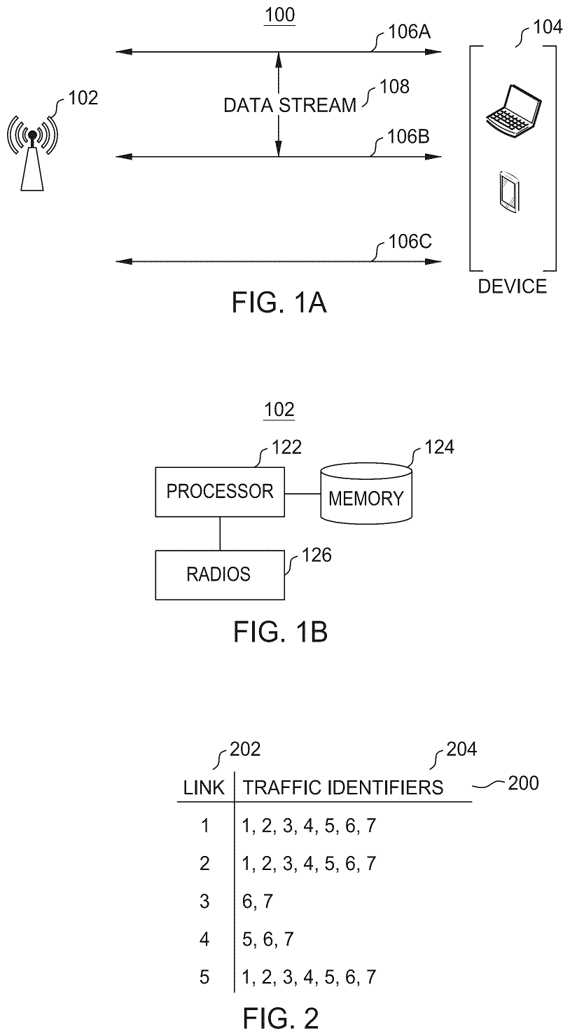

FIG. 1A illustrates an example system 100, which may be a network deployment that provides wireless communication (e.g., wireless fidelity (Wi-Fi) communications). As seen in FIG. 1A, the system 100 includes an access point 102 and a device 104 (which may also be referred to as a client device). Generally, the access point 102 provides multiple links over which the access point 102 and/or the device 104 may communicate data streams to each other. The access point 102 may determine which data streams are subject to QoS requirements and carry those data streams on links that are reserved for these data streams or that prioritize these data streams.

The access point 102 facilitates wireless communication in the system 100. The device 104 may connect to the access point 102. The access point 102 may then facilitate wireless communication for the device 104. For example, the device 104 may communicate a message or data stream to the access point 102. The access point 102 may route the message or data stream towards its destination. As another example, the access point 102 may receive a message or data stream for the device 104. The access point 102 may direct the message or data stream to the device 104.

The access point 102 provides multiple links 106 that can be used to communicate messages or data streams 108 between the access point 102 and the device 104. Each link 106 or set of links 106 may support a different frequency band. The access point 102 and device 104 may use different radios to communicate over different links 106. In the example of FIG. 1A, the access point 102 provides the links 106A, 106B, and 106C. Each link 106A, 106B, 106C may support a different frequency band (e.g., the 2.4 gigaHertz (GHz), the 5 GHz band, and/or the 6 GHz band).

The access point 102 may communicate a data stream 108 to the device 104 (and vice versa) using one of the links 106A, 106B, or 106C. The data stream 108 may include or carry multiple messages that support an end application. Some types of data streams 108 may be subject to QoS requirements. For example, data streams 108 that support videoconferencing applications or virtual reality applications may be subject to strict QoS requirements that require a certain level of performance to avoid disrupting the applications. For example, the QoS requirements may indicate thresholds or minimums for certain performance metrics such as bandwidth, uplink speed, downlink speed, throughput, etc. On the other hand, some types of data streams 108 may not be subject to QoS requirements or may be subject to relaxed QoS requirements. For example, data streams 108 that support chat or messaging applications or web browsing applications may be subject to relaxed QoS requirements or no QoS requirements.

To avoid disruption in applications that are subject to QoS requirements, the access point 102 may prioritize data streams 108 for these applications on certain links 106 or reserve certain links 106 for these data streams 108. When the access point 102 detects or encounters a data stream 108 that is subject to QoS requirements, the access point 102 may carry the data stream 108 on one of these links 106, which sets the data stream 108 apart from other data streams that may be subject to relaxed QoS requirements or no QoS requirements. As a result, the data stream 108 may experience less interference and congestion, which reduces or eliminates disruption for the end application, in certain embodiments.

Generally, each data stream 108 includes or uses a traffic identifier that indicates the type of traffic carried by the data stream 108. Specifically, the traffic identifier may provide an indication whether the data stream 108 is subject to QoS requirements. The access point 102 may map certain traffic identifiers to certain links 106. Some links 106 may be mapped to every traffic identifier, indicating that all types of traffic may be communicated over those links. Some links 106 may be mapped to only a few traffic identifiers (e.g., traffic identifiers for traffic that is subject to QoS requirements). These links 106 are reserved for these traffic identifiers or prioritize these traffic identifiers. When the access point 102 receives a data stream 108 with a particular traffic identifier, the access point 102 determines whether there is a link 106 that is mapped to the traffic identifier but not all traffic identifiers, indicating that the link 106 is reserved for or prioritizes the traffic identifier. If so, the access point 102 carries the data stream 108 on that link 106.

The device 104 may be any suitable device that wirelessly connects to the access point 102. As an example and not by way of limitation, the device 104 may be a computer, a laptop, a wireless or cellular telephone, an electronic notebook, a personal digital assistant, a tablet, or any other device capable of receiving, processing, storing, or communicating information with other components of the system 100. The device 104 may be a wearable device such as a virtual reality or augmented reality headset, a smart watch, or smart glasses. The device 104 may also include a user interface, such as a display, a microphone, keypad, or other appropriate terminal equipment usable by the user. The device 104 may include a hardware processor, memory, or circuitry configured to perform any of the functions or actions of the device 104 described herein. For example, a software application designed using software code may be stored in the memory and executed by the processor to perform the functions of the device 104.

FIG. 1B illustrates an example access point 102 in the system of FIG. 1A. As seen in FIG. 1B, the access point 102 includes a processor 122, a memory 124, and one or more radios 126.

The processor 122 is any electronic circuitry, including, but not limited to one or a combination of microprocessors, microcontrollers, application specific integrated circuits (ASIC), application specific instruction set processor (ASIP), and/or state machines, that communicatively couples to the memory 124 and controls the operation of the access point 102. The processor 122 may be 8-bit, 16-bit, 32-bit, 64-bit or of any other suitable architecture. The processor 122 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 122 may include other hardware that operates software to control and process information. The processor 122 executes software stored on the memory 124 to perform any of the functions described herein. The processor 122 controls the operation and administration of the access point 102 by processing information (e.g., information received from the memory 124 and radios 126). The processor 122 is not limited to a single processing device and may encompass multiple processing devices contained in the same device or computer or distributed across multiple devices or computers. The processor 122 is considered to perform a set of functions or actions if the multiple processing devices collectively perform the set of functions or actions, even if different processing devices perform different functions or actions in the set.

The memory 124 may store, either permanently or temporarily, data, operational software, or other information for the processor 122. The memory 124 may include any one or a combination of volatile or non-volatile local or remote devices suitable for storing information. For example, the memory 124 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 124, a disk, a CD, or a flash drive. In particular embodiments, the software may include an application executable by the processor 122 to perform one or more of the functions described herein. The memory 124 is not limited to a single memory and may encompass multiple memories contained in the same device or computer or distributed across multiple devices or computers. The memory 124 is considered to store a set of data, operational software, or information if the multiple memories collectively store the set of data, operational software, or information, even if different memories store different portions of the data, operational software, or information in the set.

The radios 126 may communicate messages or information using different communication technologies. For example, the access point 102 may use one or more of the radios 126 for Wi-Fi communications. The access point 102 may use one or more of the radios 126 to transmit messages and one or more of the radios 126 to receive messages. The access point 102 may include any number of radios 126 to communicate using any number of communication technologies.

The access point 102 may include any number of (e.g., one or multiple) processors 122 and memories 124. Generally, one or multiple processors 122 are considered to perform an operation (or configured to perform the operation) if (i) at least one of the processors 122 individually performs every step of the operation or (ii) multiple processors 122 collectively perform the steps of the operation (e.g., if one processor 122 performs the first half of the operation and another processor 122 performs the second half of the operation). Additionally, one or multiple memories 124 are considered to perform an operation (or configured to perform the operation) if (i) at least one of the memories 124 individually performs every step of the operation or (ii) multiple memories 124 collectively perform the steps of the operation (e.g., if one memory 124 performs the first half of the operation and another memory 124 performs the second half of the operation).

FIG. 2 illustrates an example mapping 200 in the system 100 of FIG. 1A. An access point (e.g., the access point 102 shown in FIG. 1A) may implement or store the mapping 200. As seen in FIG. 2, the mapping 200 indicates links 202 and traffic identifiers 204 mapped to those links 202. Some links 202 are mapped to many traffic identifiers 204, and other links 202 are mapped to a few traffic identifiers 204, which indicates that those links 202 are reserved for or prioritize traffic with those traffic identifiers 204. The mapping 200 may include any number of links 202, and each link 202 may be assigned to any number of traffic identifiers 204.

In the example of FIG. 2, Links 1, 2, and 5 are mapped to the traffic identifiers 1, 2, 3, 4, 5, 6, and 7. Additionally, Link 3 is mapped to the traffic identifiers 6 and 7, and Link 4 is mapped to the traffic identifiers 5, 6, and 7. As a result, the mapping 200 indicates that Links 1, 2, and 5 handle all types of traffic. The mapping 200 also indicates that Link 3 is reserved for or prioritizes traffic with the traffic identifiers 6 and 7 and that Link 4 is reserved for or prioritizes traffic with the traffic identifiers 5, 6, and 7. The traffic identifiers 5, 6, and 7 may identify traffic that is subject to QoS requirements, and the traffic identifiers 1, 2, 3, and 4 may identify traffic that is not subject to QoS requirements. When the access point receives traffic with the traffic identifiers 5, 6, or 7, the access point may determine from the mapping 200, that the traffic should be carried on Links 3 and/or 4.

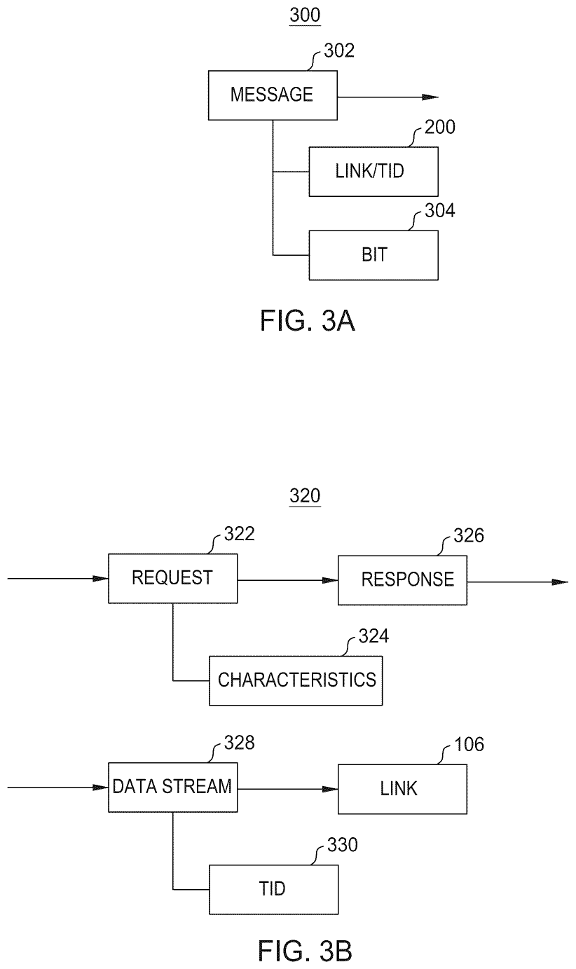

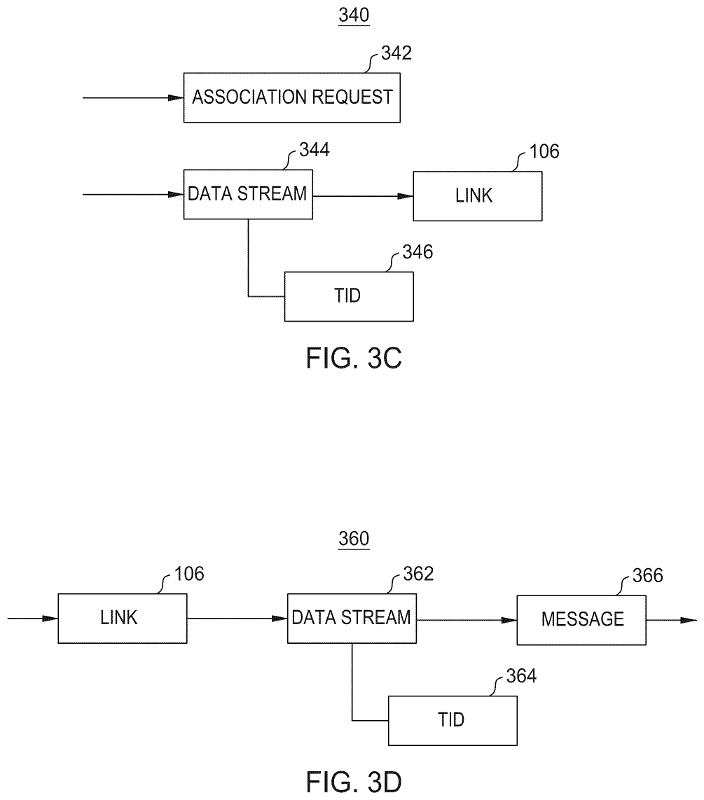

FIGS. 3A through 3D illustrate example operations performed by the system of FIG. 1A. Generally, an access point (e.g., the access point 102 shown in FIG. 1A) performs these operations to carry traffic subject to QoS requirements on certain links (which may also be referred to as premium links). For these operations, the access point advertises the links for traffic that is subject to QoS requirements.

FIG. 3A shows an example operation 300 performed by the access point. The access point begins by generating a message 302 that advertises the mapping 200 for the access point. The mapping 200 may indicate the traffic identifiers that are linked to the links supported by the access point. For example, the mapping 200 may show which links are mapped to traffic identifiers (TIDs) for traffic subject to QoS requirements. As a result, the message 302 indicates the links that carry traffic or data streams subject to QoS requirements. In some embodiments, the message 302 includes an element (which may be referred to as a traffic identifier-to-link mapping (TTLM) element) that contains the mapping 200. The access point may broadcast the message 302 to multiple devices within range of the access point. For example, the message 302 may be a beacon, probe response, fast initial link setup response, association response, reassociation response, etc. Multiple devices or access points may receive the message 302 and determine the mapping 200 supported by the access point using the message 302. In this manner, the access point advertises the mapping 200 to a device or access point that receives the message 302.

In certain embodiments, the access point adds a bit 304 to the message 302 to indicate a premium link that supports traffic subject to QoS requirements. Additionally, the message 302 may indicate the traffic identifiers mapped to that link. In this manner, the bit 304 marks or identifies the links that are premium link.

FIG. 3B shows an example operation 320 performed by the access point to provide access to a premium link for traffic subject to QoS requirements. The access point begins by performing an exchange or negotiation (e.g., a stream classification services (SCS) exchange or negotiation or a TTLM exchange or negotiation) with a device (e.g., a client device). The access point receives a request 322 from the device to seek access to a premium link for certain traffic. For example, the request 322 may indicate characteristics 324 of the traffic (e.g., QoS characteristics or traffic identifiers) that the device wants to communicate using a premium link. The access point analyzes the request 322 to determine whether or not that traffic is mapped to a premium link. In some instances, even though the traffic is not mapped to a premium link, the access point may still map the traffic to the premium link in response to the request.

The access point communicates a response 326 to the device to indicate whether the device is granted access to the premium link to communicate the traffic with the characteristics 324. The response 326 may also indicate or identify the link that the device may use to communicate the traffic. After supplying the response 326, the exchange or negotiation may be considered successful.

As an example, the access point or the device may initiate a SCS negotiation to indicate that certain traffic types or identifiers are subject to QoS requirements or to request that certain traffic types or identifiers to be treated like the traffic is subject to QoS requirements. In response, the access point may log that certain traffic types or identifiers are subject to QoS requirements. The SCS negotiation may further include negotiating QoS characteristics parameters for traffic or data streams. These parameters may include delay bound, minimum data rate, service internal, start time, burst size, etc. The access point or the device may initiate a TTLM negotiation (e.g., after the SCS negotiation) to map certain traffic types or identifiers to premium links. For example, the device may request (e.g., using the request 322) that certain traffic types or identifiers be mapped to premium links, or the access point may determine that certain traffic types or identifiers should be mapped to premium links (e.g., due to the traffic types or identifiers being subject to QoS requirements). The access point may indicate to the device (e.g. using the response 326) the traffic types or identifiers that are mapped to premium links, and the device may follow the mapping provided by the access point. In some embodiments, the SCS negotiation and/or the TTLM negotiation occur when the device is associating with the access point (e.g., during the association process).

The access point may then receive a data stream 328 from the device. The data stream 328 may have a traffic identifier 330 that is mapped to the premium link. When the access point receives the data stream 328, the access point analyzes the traffic identifier 330 to determine whether the traffic identifier 330 is mapped to a link reserved for or that prioritizes the traffic identifier 330. If so, the access point may carry the data stream 328 on that link 106. The access point may then communicate the data stream 328 with the device using the link 106. In this manner, the access point provides the device access to a premium link on demand, when the device requests access to the premium link for certain types of traffic. In some embodiments, the access point carries the data stream 328 on the link 106 after the SCS exchange and/or the TTLM negotiation for the traffic identifier 330 and the link 106 are successful.

FIG. 3C shows an example operation 340 performed by the access point to provide access to a premium link for traffic subject to QoS requirements. The operation 340 may be an alternative to the operation 320 shown in FIG. 3B. The access point begins by receiving an association request 342 from a device. The device may communicate the association request 342 when the device is attempting to connect to or associate with the access point. The device may communicate the request after the access point has broadcasted the message 302 shown in FIG. 3A to the device. The message 302 may indicate to the device the mapping of links and traffic identifiers supported by the access point. In the association request 342, the device may indicate an intent to comply with the mapping provided by the access point.

The access point may then receive a data stream 344 from the device. The data stream 344 may have a traffic identifier 346 that is mapped to a premium link. The access point may provide access to the premium by carrying the data stream 344 on the link 106. The access point may confirm that the traffic identifier 346 is mapped to the premium link before carrying the data stream 344 on the link 106. If the traffic identifier 346 is not mapped to the premium link, then the access point may refuse to carry the data stream 344 on the link 106.

In some embodiments, the access point may use a combination of the operation 320 shown in FIG. 3B and the operation 340 shown in FIG. 3C to provide access to the premium link. For example, the access point may request that the device perform the SCS exchange to establish that traffic having certain characteristics or traffic identifiers is sent over the premium link. Additionally, the access point may require that the device indicate compliance with the mapping provided by the access point before providing access to the premium link.

FIG. 3D shows an example operation 360 performed by the access point. The access point begins by receiving a data stream 362 over the link 106 from a device. The data stream 362 has a traffic identifier 364. The access point may determine whether the traffic identifier 364 is mapped to the link 106 using a mapping. If the access point determines that the traffic identifier 364 is not mapped to the link 106, then the access point determines that the data stream 362 is non-compliant. The access point then communicates a message 366 to the device indicating that the device should perform an exchange and/or negotiation (e.g., an SCS exchange and/or TTLM negotiation) with the access point before continuing with the data stream over the link 106. The access point may also include the mapping in the message 366 to indicate to the device other links that are available for the device to use to communicate the data stream. In some embodiments, the access point initiates the exchange and/or negotiation with the device (e.g., by communicating the message 366 to request the exchange and/or negotiation). If the device does not perform the exchange and/or negotiation with the access point, then the access point may carry the data stream 362 on one of those links. If the device performs the exchange and/or negotiation and the exchange and/or negotiation are successful, then the access point may map the traffic identifier 364 to the link 106 as part of the negotiation.

In certain embodiments, the access point may carry a data stream on a link by moving the data stream from another link to the link. In some instances, the access point carries the data stream on the link by ceasing communication of the data stream over another link and commending communication of the data stream over the link. In certain instances, the access point carries the data stream on the link by instructing the device to communicate the data stream over the link. The device may then communicate the data stream over the link.

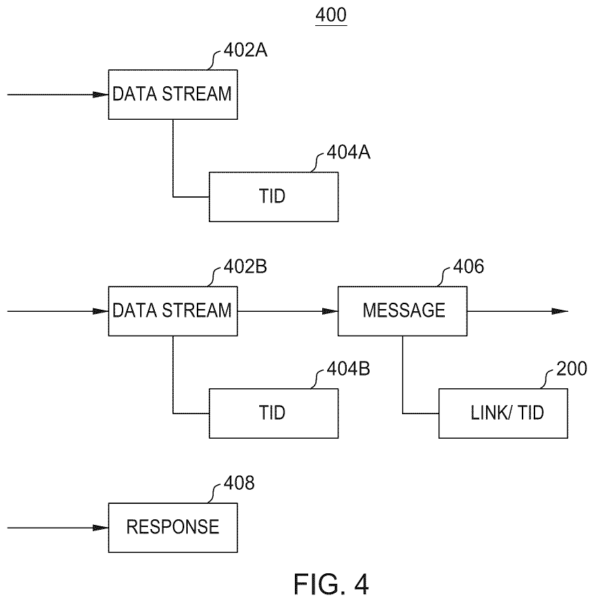

FIG. 4 illustrates an example operation 400 performed by the system 100 of FIG. 1A. Generally, an access point (e.g., the access point 102 shown in FIG. 1A) performs the operation 400 to detect non-compliant devices or traffic. The access point begins by receiving multiple data streams 402. The data streams 402 may be received over one or more premium links. The data streams 402 may also have traffic identifiers 404 indicating the type of traffic communicated by the data streams 402. In the example of FIG. 4, the access point receives the data streams 402A and 402B. The data stream 402A has a traffic identifier 404A, and the data stream 402B has the traffic identifier 404B. The data stream 402A may be communicated by a different device than the data stream 402B.

The access point may determine that the data stream 402A is compliant and that the data stream 402B is non-compliant. For example, the access point may determine, from a mapping 200, that the traffic identifier 404A is mapped to a premium link and that the traffic identifier 404B is not mapped or unmapped to a premium link. As another example, the access point may determine that the device that sent the data stream 402A is authorized to access a premium link and that the device that sent the data stream 402B is not authorized to access a premium link.

In response, the access point generates and communicates a message 406 to the device that communicated the data stream 402B to take corrective action. The message 406 may include the mapping 200 for the access point to indicate to the device the appropriate link for the data stream 402B with the traffic identifier 404B. The access point may also stop directing or further communicating the data stream 402B. In some instances, the message 406 may indicate that an SCS negotiation and/or TTLM negotiation should be performed prior to continuing the data stream 402B. The device that communicated the data stream 402B may then perform the SCS negotiation and/or TTLM negotiation with the access point to determine whether the traffic identifier for the data stream 402B can be mapped to a premium link.

In certain embodiments, the access point may allow a premium link to carry the data stream 402B for limited periods of time even though the traffic identifier for the data stream 402B is not mapped to a premium link. The access point may broadcast a message indicating when a premium link may be used to carry data streams with traffic identifiers that are not mapped to the premium link. For example, the message may indicate certain time periods when the premium link may be used to carry these data streams. The device that communicated the data stream 402B may then communicate the data stream 402B using the premium link at the indicated time periods.

The access point may receive a response 408 to the message 406 from the device. The response 408 may include a confirmation from the device that the device will comply with the mapping 200. The device may then communicate the data stream 402B over a different link. Additionally or alternatively, the response 408 may form part of a process by which the device negotiates access to the premium link with the access point. By performing the negotiation (e.g., SCS negotiation), the access point may grant the device access to the premium link. The device may then communicate the data stream 402B over the premium link.

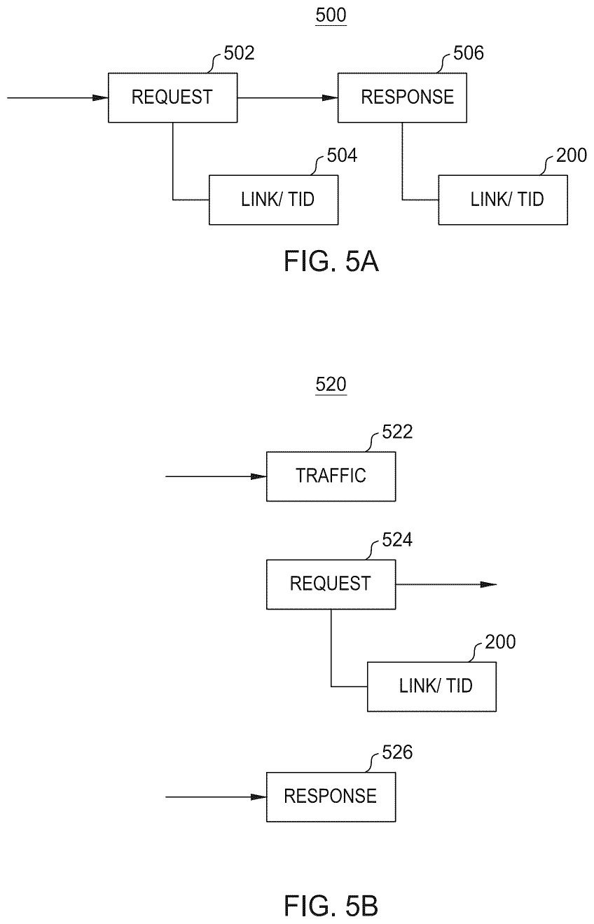

FIGS. 5A and 5B illustrate example operations performed by the system 100 of FIG. 1A. Generally, an access point (e.g., the access point 102 shown in FIG. 1A) performs the operations to negotiate access to the premium link with a device.

FIG. 5A shows an example operation 500 in which a device initiates the negotiation. The access points begins by receiving a request 502 from the device. The request 502 may request access to a premium link for certain traffic identifiers. For example, the request 502 from the device may include a mapping 504. The mapping 504 may indicate that the device is requesting that certain traffic identifiers be mapped to certain links.

The access point evaluates the request 502 and the mapping 504 to determine whether the mapping 200 in the access point should be updated to accommodate the request 502. For example, the access point may determine whether there are sufficient link resources available to handle or accommodate the changes to the mapping 200. If there are sufficient link resources, the access point may change the mapping 200 to include some of the link-traffic identifier mappings in the mapping 504. If there are insufficient link resources, the access point may leave the mapping 200 unchanged.

The access point generates and communicates a response 506 to the device. The response 506 may include the mapping 200. If the mapping 200 is updated, the response 506 includes the updated mapping 200. If the mapping 200 is not updated, then the response 506 indicates the traffic identifiers that were previously mapped to the premium link. The access point communicates the response 506 and the mapping 200 to the device to indicate to the device the link-traffic identifier mappings that the device should follow when communicating data streams. The device then knows which links are premium links and what traffic identifiers are mapped to those premium links. The device may then communicate data streams to the access point according to the mapping 200.

FIG. 5B shows an example operation 520 in which the access point initiates the negotiation. The access point begins by detecting traffic 522. For example, the access point may receive or scan for the traffic 522 in the network or system. The access point may determine that the traffic 522 includes one or more data streams with traffic identifiers that are mapped to premium links by the access point. The access point may additionally detect that these data streams are not being communicated over premium links.

In response, the access point generates and communicates a request 524 to one or more devices communicating these data streams. For example, the access point may individually address the request 524 to a specific device, or the access point may broadcast, groupcast, or multicast the request 524 to multiple devices. In some instances, the request 524 may be a beacon, probe response, fast initial link setup response, association response, or reassociation response. The request 524 may include or indicate the mapping 200 used by the access point. The mapping 200 may indicate the traffic identifiers that are mapped to premium links.

The device(s) may accept or reject the mapping 200 provided by the access point. For example, a device may communicate a response 526 to the access point. The response 526 may indicate whether the device accepts or rejects the mapping 200. If the device accepts the mapping, the access point may carry a data stream communicated by the device on a premium link. For example, the access point may instruct or expect the device to communicate the data stream using the premium link. If the device rejects the mapping 200 in the response 526, then the access point may instruct or expect the device to communicate the data stream using a non-premium link (e.g., a link that is mapped to every traffic identifier).

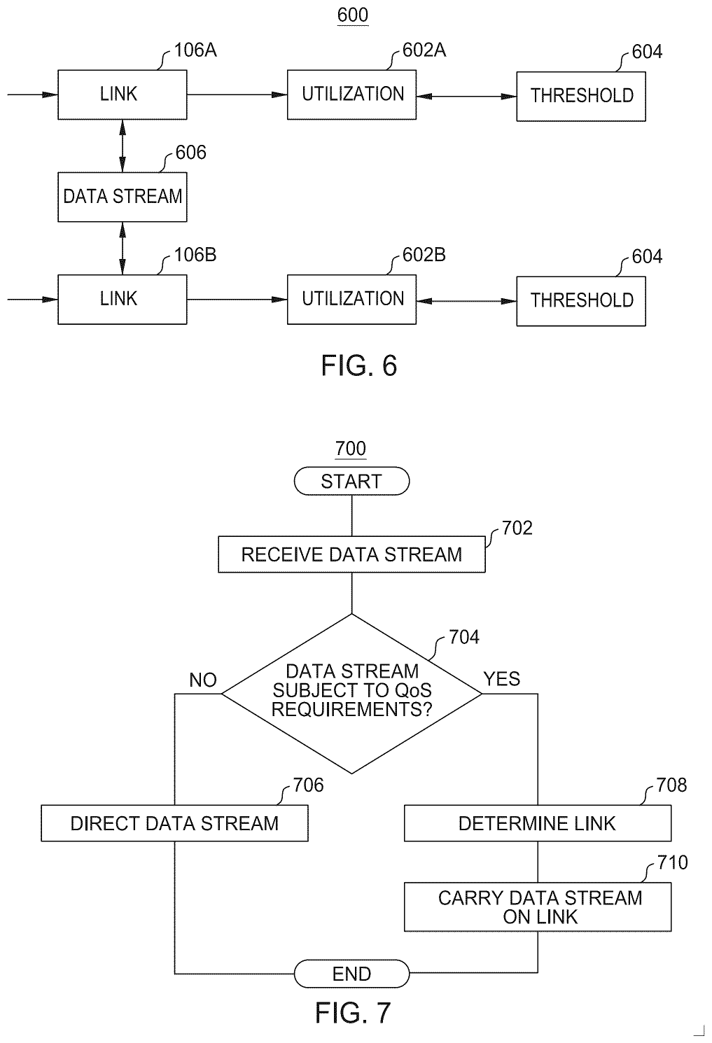

FIG. 6 illustrates an example operation 600 performed by the system 100 of FIG. 1A. Generally, an access point (e.g., the access point 102 shown in FIG. 1A) performs the operation 600 to allow access to a premium link based on utilization.

As seen in FIG. 6, the access point supports a link 106A and a link 106B. Both links 106A and 106B may be premium links that are reserved for or prioritizes data streams subject to QoS requirements (e.g., videoconferencing data streams, virtual reality data streams, etc.). The access point receives the data stream 606. The data stream 606 may not be subject to QoS requirements. As a result, the traffic identifier for the data stream 606 may not be mapped to the links 106A and 106B.

Although the traffic identifier for the data stream 606 is not mapped to the links 106A and 106B, the access point may still carry the data stream 606 on the link 106A or the link 106B to prevent underutilization of the link 106A or the link 106B. For example, the access point may determine utilizations 602 of the links 106A and 106B (e.g., a utilization 602A for the link 106A and a utilization 602B for the link 106B). The utilization may indicate an amount of traffic or data streams being communicated over the links 106A and 106B. The access point may measure the traffic from the data streams on the links 106A and 106B to determine the utilizations 602.

The access point compares the utilizations 602 with one or more thresholds 604 to determine whether the links 106A and 106B are underutilized. For example, if the utilization 602A or 602B falls below a threshold 604, then the access point may determine that the link 106A or the link 106B, respectively, is underutilized. The access point may implement different thresholds 604 for the links 106A and 106B that establish different underutilization conditions for the links 106A and 106B.

If the access point determines that a link 106A or 106B is underutilized, the access point may carry the data stream 606 on that link 106A or 106B to increase utilization. For example, if the utilization 602A falls below a threshold 604, the access point may carry the data stream 606 on the link 106A to increase utilization of the link 106A. If conditions change (e.g., more data streams appear on the link 106A and data streams drop off the link 106B), then the access point may determine that the link 106A is no longer underutilized and that the link 106B is underutilized. The access point may then carry the data stream on the link 106B to increase utilization of the link 106B.

In certain embodiments, the access point implements tiers or levels of thresholds 604 for the links 106. Each tier indicates a different level of utilization. The access point may implement any number of tiers or levels of thresholds, and the access point may reduce the subset of devices allowed to use the link 106 for any data streams with each successive threshold. For example, the access point may implement a first threshold (e.g., 50% utilization) below which the access point allows all devices to use the link 106 for any data streams. The access point may implement a second threshold (e.g., 60% utilization). When the utilization 602 is between the first threshold and the second threshold, the access point may allow only a subset of devices to use the link 106 for any data streams. When the utilization 602 exceeds the second threshold, the access point may reserve the link 106 for data streams that are subject to QoS restrictions.

FIG. 7 is a flowchart of an example method 700 performed by the system 100 of FIG. 1A. In certain embodiments, an access point (e.g., the access point 102 shown in FIG. 1A) performs the method 700. By performing the method 700, the access point carries data streams subject to QoS restrictions on links that prioritize or are reserved for these data streams.

In block 702, the access point receives a data stream from a device. The data stream may have a traffic identifier that indicates the type of data stream or the type of end application supported by the data stream. Certain traffic identifiers may indicate that the data stream is subject to QoS requirements. For example, the traffic identifiers may indicate that the data stream is a videoconferencing data stream or a virtual reality data stream.

In block 704, the access point determines whether the data stream is subject to QoS requirements by examining the traffic identifier for the data stream. In some embodiments, the access point compares the traffic identifier to a mapping. The mapping may map traffic identifiers to links. Some links may be mapped to every traffic identifier, and some links may be mapped to only a few traffic identifiers. If the traffic identifier for the data stream is mapped to a link that is mapped to only a few traffic identifiers, then the data stream may be subject to QoS requirements.

If the access point determines that the data stream is not subject to QoS requirements, then the access point may direct the data stream in block 706 to a link that is mapped to every traffic identifier. The access point may then communicate the data stream over that link. The access point may select the link using a load balancing technique, or the access point may select the link based on utilization of the link (e.g., the least utilized link that is mapped to every traffic identifier).

If the access point determines that the data is stream is subject to QoS requirements, then the access point determines a link for the data stream in block 708. The access point may determine the link using the mapping. For example, the access point may identify, from the links that are mapped to only a few traffic identifiers or less than every traffic identifier, the links that are mapped to the traffic identifier for the data stream. The access point may then select, from these links, a link to handle the data stream. For example, the access point may select the link using a load balancing technique or based on utilization of the link (e.g., the least utilized link).

In block 710, the access point carries the data stream on the selected link. For example, the access point may instruct the device communicating the data stream to communicate the data stream over the selected link. As another example, the access point may expect the device to communicate the data stream over the selected link. By carrying the data stream on the selected link, the access point may separate the data stream from other data streams that may interfere with or otherwise degrade the performance of the link, which may improve the likelihood that the access point meets or satisfies the QoS requirements.

In summary, the access point 102 carries data streams subject to QoS requirements on links that are mapped to handle such traffic. Generally, the access point 102 implements multiple links, and the access point 102 maintains a mapping that indicates the traffic identifiers handled by each link. The traffic identifiers identify types of traffic included in data streams. Certain traffic identifiers indicate traffic that is subject to QoS requirements. Some of the links may be mapped to every traffic identifier (e.g., indicating that those links may handle every type of traffic), but some links may be mapped to only traffic identifiers for traffic subject to QoS requirements. When the access point 102 receives a data stream with a traffic identifier indicating traffic subject to QoS requirements, the access point may determine, from the mapping, the links that are mapped to only traffic identifiers for traffic subject to QoS requirements. The access point may then carry the data stream on one or more of these links.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. An access point comprising:
one or more memories; and
one or more processors communicatively coupled to the one or more memories, the one or more processors configured to, individually or collectively:
determine, based on a first traffic identifier for a first data stream, that the first data stream is subject to quality of service (QOS) requirements;
in response to determining that the first data stream is subject to QoS requirements, determine a first link that is mapped to the first traffic identifier; and
carry the first data stream on the first link.

2. The access point of claim 1, wherein the one or more processors are further configured to, individually or collectively, broadcast a message indicating that the first link is mapped to the first traffic identifier.

3. The access point of claim 2, wherein the message is a beacon, a probe response, an association response, or a reassociation response.

4. The access point of claim 2, wherein the message indicates that the first link carries data streams subject to QoS requirements.

5. The access point of claim 2, wherein the message comprises a traffic identifier-to-link mapping (TTLM) element that indicates that the first link is mapped to the first traffic identifier.

6. The access point of claim 1, wherein the one or more processors are further configured to, individually or collectively, perform a stream classification service (SCS) negotiation for the first data stream with a device that communicated the first data stream.

7. The access point of claim 6, wherein the SCS negotiation comprises negotiating QoS characteristics parameters for the first data stream.

8. The access point of claim 6, wherein carrying the first data stream on the first link is based on the SCS negotiation with the device being successful.

9. The access point of claim 6, wherein carrying the first data stream on the first link is based on TTLM negotiation with the device being successful.

10. The access point of claim 1, wherein the one or more processors are further configured to, individually or collectively:
receive, from a device, a second data stream with a second traffic identifier that is unmapped to the first link; and
perform a TTLM negotiation with the device based on the second traffic identifier being unmapped to the first link.

11. The access point of claim 10, wherein the one or more processors are further configured to, individually or collectively, broadcast a message indicating when first link is allowed to carry the second data stream.

12. The access point of claim 1, wherein the one or more processors are further configured to, individually or collectively and in response to determining that the first data stream is being communicated by a device, communicate a message to the device indicating that the first traffic identifier is mapped to the first link.

13. The access point of claim 1, wherein the one or more processors are further configured to, individually or collectively:
receive a request from a device that a second traffic identifier be mapped to the first link; and
in response to the request, communicate a response to the device indicating the first traffic identifier mapped to the first link.

14. The access point of claim 1, wherein the one or more processors are further configured to, individually or collectively:
determine a utilization of the first link; and
in response to determining that the utilization falls below a threshold, carrying a second data stream on the first link, wherein the second data stream has a second traffic identifier that is unmapped to the first link.

15. A method comprising:
determining, based on a first traffic identifier for a first data stream, that the first data stream is subject to QoS requirements;
in response to determining that the first data stream is subject to QoS requirements, determining a first link that is mapped to the first traffic identifier; and
carrying the first data stream on the first link.

16. The method of claim 15, further comprising broadcasting a message indicating that the first link is mapped to the first traffic identifier.

17. The method of claim 16, wherein the message is a beacon, a probe response, an association response, or a reassociation response.

18. The method of claim 15, further comprising performing an SCS negotiation for the first data stream with a device that communicated the first data stream.

19. The method of claim 18, wherein carrying the first data stream on the first link is based on the SCS negotiation with the device being successful.

20. A non-transitory computer readable medium storing instructions that, when executed by one or more processors, cause the one or more processors to:
determine, based on a first traffic identifier for a first data stream, that the first data stream is subject to QoS requirements;
in response to determining that the first data stream is subject to QoS requirements, determine a first link that is mapped to the first traffic identifier; and
carry the first data stream on the first link.
